(19) United States
(12) Patent Application Publication
(10) Pub. No.: US 2025/0094806 A1
(43) Pub. Date: Mar. 20, 2025

(54) LARGE LANGUAGE MODEL TRAINING METHOD, ELECTRONIC DEVICE, AND STORAGE MEDIUM

(71) Applicant: Beijing Baidu Netcom Science Technology Co., Ltd., Beijing (CN)

(72) Inventors: Junyuan Shang, Beijing (CN); Yilong Chen, Beijing (CN); Zhenyu Zhang, Beijing (CN); Shuohuan Wang, Beijing (CN); Yu Sun, Beijing (CN); Hua Wu, Beijing (CN)

(21) Appl. No.: 18/967,167

(22) Filed: Dec. 3, 2024

(30) Foreign Application Priority Data
May 14, 2024 (CN) 202410599492.4

(51) Int. Cl. G06N 3/082; G06N 3/0475

(52) U.S. Cl. CPC G06N 3/082; G06N 3/0475

(57) ABSTRACT

Provided is a large language model training method, an electronic device and a storage medium, relating to the field of artificial intelligence technologies, and in particular, to the fields of deep learning, natural language processing and large model. The method includes: performing dimension reduction parameter fusion on a two-dimensional parameter matrix on each channel in each network layer in a first large language model, respectively, to obtain a second large language model; performing layer reduction parameter fusion on network layers in the second large language model based on a three-dimensional parameter matrix of each network layer in the second large language model to obtain a third large language model; and training the third large language model to obtain a target large language model under the condition that the target loss function determined based on the first and third large language models meets a preset first function condition.

### CROSS-REFERENCE TO RELATED APPLICATIONS

The present application claims priority to Chinese Patent Application No. CN202410599492.4, filed with the China National Intellectual Property Administration on May 14, 2024, the disclosure of which is hereby incorporated herein by reference in its entirety.

### TECHNICAL FIELD

The disclosure relates to the field of artificial intelligence technologies, and in particular, to the fields of deep learning, natural language processing and large model. The disclosure specifically relates to a large language model training method and apparatus, an electronic device and a storage medium.

### BACKGROUND

With the continuous improvement of artificial intelligence technologies, a Natural Language Processing (NLP) model has also entered the era of very large-scale model. By leveraging super-strong computing power, a Large Language Model (Large Language Model, LLM) with a super-Large parameter scale is obtained through training on massive text data, and the Large Language Model can have multi-task and few-sample learning capabilities for semantic understanding and generation. However, given the computational resources and memory footprint involved in model training, using large language models with relatively small parametric sizes is a more cost-effective option in commercial deployment.

### SUMMARY

The disclosure provides a large language model training method and apparatus, an electronic device and a storage medium.

According to an aspect of the present disclosure, provided is a large language model training method, including:
performing dimension reduction parameter fusion on a two-dimensional parameter matrix on each channel in each network layer in a first large language model, respectively, to obtain a second large language model;
performing layer reduction parameter fusion on network layers in the second large language model based on a three-dimensional parameter matrix of each network layer in the second large language model to obtain a third large language model;
determining a target loss function based on the first large language model and the third large language model; and
training the third large language model to obtain a target large language model under the condition that the target loss function meets a preset first function condition.

According to another aspect of the present disclosure, provided is a large language model training apparatus, including:
a dimension reduction parameter fusion module, configured to perform dimension reduction parameter fusion on a two-dimensional parameter matrix on each channel in each network layer in a first large language model, respectively, to obtain a second large language model;
a layer reduction parameter fusion module, configured to perform layer reduction parameter fusion on network layers in the second large language model based on a three-dimensional parameter matrix of each network layer in the second large language model to obtain a third large language model;
a target function determination module, configured to determine a target loss function based on the first large language model and the third large language model; and
a model training module, configured to train the third large language model to obtain a target large language model under the condition that the target loss function meets a preset first function condition.

According to another aspect of the present disclosure, provided is an electronic device, including:
at least one processor; and
a memory connected in communication with the at least one processor,
wherein the memory stores an instruction executable by the at least one processor, and the instruction, when executed by the at least one processor, enables the at least one processor to execute any one of the large language model training methods according to the embodiments of the present disclosure.

According to another aspect of the present disclosure, provided is a non-transitory computer readable storage medium storing a computer instruction wherein the computer instruction causes a computer to perform any one of the large language model training methods according to the embodiments of the present disclosure.

According to another aspect of the present disclosure, provided is a computer program product including a computer program, wherein the computer program, when executed by a processor, implements any one of the large language model training methods according to the embodiments of the present disclosure.

According to the technology of the disclosure, the dimension reduction parameter fusion is carried out on the two-dimensional parameter matrix on each subdivided channel in each network layer in the first large language model to obtain the second large language model, then the layer reduction parameter fusion is carried out on the network layers of the second large language model to obtain a third large language model with smaller parameter scale, and if the loss function corresponding to the first large language model and the third large language model meet the first function condition, the third large language model is trained to obtain the target large language model. As such, the computing resources and memory resources occupied in the training process of the large language model can be reduced while the training effect of the large language model is ensured.

It should be understood that the content described in this part is not intended to identify critical or essential features of embodiments of the present disclosure, nor is it used to limit the scope of the present disclosure. Other features of the present disclosure will be easily understood through the following description.

### BRIEF DESCRIPTION OF THE DRAWINGS

The accompanying drawings are used to better understand the present solution, and do not constitute a limitation to the present disclosure, in which:

FIG. 1 is a flow diagram of a large language model training method according to an embodiment of the present disclosure;

FIG. 2 is a schematic diagram illustrating a degree of similarity between parameters of each network layer in the large language model according to an embodiment of the present disclosure;

FIG. 3 is a schematic diagram illustrating a degree of similarity between parameters of each network layer in the large language model according to another embodiment of the present disclosure;

FIG. 4 is a schematic diagram illustrating a fusion process of a large language model according to an embodiment of the present disclosure;

FIG. 5 is a schematic diagram illustrating a dimension fusion process of a large language model according to an embodiment of the present disclosure;

FIG. 6 is a schematic diagram illustrating a layer fusion process of a large language model according to an embodiment of the present disclosure;

FIG. 7 is a block diagram of a large language model training apparatus according to an embodiment of the present disclosure;

FIG. 8 is a block diagram of a large language model training apparatus according to another embodiment of the present disclosure; and

FIG. 9 is a block diagram of an electronic device according to an embodiment of the disclosure.

### DETAILED DESCRIPTION

Hereinafter, descriptions to exemplary embodiments of the present disclosure are made with reference to the accompanying drawings, include various details of the embodiments of the present disclosure to facilitate understanding, and should be considered as merely exemplary. Therefore, those having ordinary skill in the art should appreciate that various changes and modifications may be made to the embodiments described herein without departing from the scope and spirit of the present disclosure. Likewise, for clarity and conciseness, descriptions of well-known functions and structures are omitted in the following descriptions.

In order to facilitate understanding of the large language model training method according to the embodiment of the present disclosure, the following description is made on the related technologies to the embodiments of the present disclosure, and the following related technologies may be arbitrarily combined with the technical solutions of the embodiments of the present disclosure as alternatives, which all belong to the protection scope of the embodiments of the present disclosure.

In some technologies, parameters of a large language model with a small parameter scale are initialized randomly, and then the large language model with the small parameter scale is pre-trained or trained by using massive text training data to obtain a target large language model. However, this technique cannot use an existing large language model with a large parameter scale and high precision. Moreover, the training process of the large language model with the smaller parameter scale still occupies larger computing resources and memory resources, lowering the training efficiency.

In some technologies, redundant parameter positioning is performed on an existing large language model with a large parameter scale and high precision, and then redundant parameters of the large language model are deleted to obtain a large language model with compact parameters. Then, the large language model with the compact parameters is pre-trained or trained to obtain a target large language model. However, if the redundant parameter positioning is not accurate, the language processing capability of the large language model obtained after the cropping may be reduced, and the precision of the target large language obtained by training the large language model after the cropping may not meet the requirement.

Accordingly, the present disclosure provides a large language model training method which can overcome the above-mentioned drawbacks.

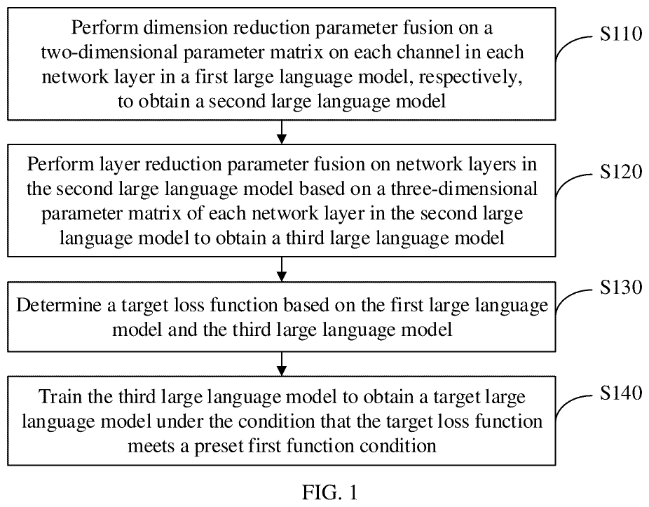

FIG. 1 is a flow diagram of a large language model training method according to an embodiment of the present disclosure. The method can be applied to an electronic device. The electronic device is, for example, a terminal, a server, or other processing devices, where the terminal may be a User Equipment (UE) such as a desktop computer, a mobile device, a PDA (Personal Digital Assistant), a handheld device, a computing device, a vehicle-mounted device, or a wearable device. In some implementations, the electronic device can implement the large language model training method according to the embodiment of the present disclosure by invoking a computer readable instruction stored in a memory through a central processing unit.

As shown in FIG. 1, the method may include steps of:
S110, performing dimension reduction parameter fusion on a two-dimensional parameter matrix on each channel in each network layer in a first large language model, respectively, to obtain a second large language model;
S120, performing layer reduction parameter fusion on network layers in the second large language model based on a three-dimensional parameter matrix of each network layer in the second large language model to obtain a third large language model;
S130, determining a target loss function based on the first large language model and the third large language model; and
S140, training the third large language model to obtain a target large language model under the condition that the target loss function meets a preset first function condition.

It should be understood that steps S110 to S130 may be executed repeatedly, and step S140 is not executed until the target loss function satisfies the preset first function condition.

It should be understood that any large language model in the embodiment of the present disclosure may understand, recognize, or generate another text.

It should be understood that, each time steps S110 to S130 are executed, the model parameters of the first large language model may also be updated. For example, the first large language model may be trained. An updated first large language model is used to perform steps S110 to S130.

It should be understood that, each execution of steps S110 to S130 can be treated as once training operation in the pre-training. The pre-training includes the steps S110 to S140, wherein the steps S110 to S130 may be executed repeatedly many times.

It should be that a model can include a plurality of network layers, such as an input layer, a full connect layer, an attention layer, an embed layer and an output layer. A single network layer may include a plurality of channels, each having a two-dimensional parameter matrix. The two-dimensional parameter matrixes on all the channels in a network layer are combined to obtain a three-dimensional parameter matrix of the network layer.

It should be understood that the two-dimensional parameter matrix includes multiple rows and columns of parameters. The three-dimensional parameter matrix includes multiple channels, rows and columns of parameters.

It should be understood that a parametric scale of the first large language model is larger than a parametric scale of the second large language model. The parametric scale of the second large language model is larger than a parametric scale of the third large language model.

For example, the row number of the two-dimensional parameter matrix on the first channel in the first network layer in the first large language model is more than or equal to the row number of the two-dimensional parameter matrix on the first channel in the first network layer in the second large language model. The column number of the two-dimensional parameter matrix on the first channel in the first network layer in the first large language model is more than or equal to the column number of the two-dimensional parameter matrix on the first channel in the first network layer in the second large language model.

For another example, the number of network layers of the first large language model is more than the number of network layers of the third large language model. The number of network layers of the first large language model is equal to the number of network layers of the second large language model. The number of network layers of the second large language model is more than the number of network layers of the third large language model.

In some embodiments, only step S110 or step S120 may be executed, that is, the above dimension reduction parameter fusion or the above layer reduction parameter fusion is executed on the first large language model with the larger parameter scale, and then the target loss function is determined by the large language model obtained by the fusion and the first large language model. If the target loss function meets the preset function condition, the large language model obtained by the fusion is trained to obtain the target large language model.

Exemplarily, the first large language model may be a trained large language model, and may remain unchanged each time steps S110 to S130 are executed. As an alternative, in addition to the first execution of steps S110 to S130, the first large language model may be updated by using the target loss function each time steps S110 to S130 are executed, and the the updated first large language model may be used to execute steps S110 to S130.

Exemplarily, the dimension reduction parameter fusion is performed on the two-dimensional parameter matrix on each channel in each network layer in the first large language model by using a dimension fusion operator, to obtain the second large language model. The layer reduction parameter fusion is performed on the network layers in the second large language model based on the three-dimensional parameter matrix of each network layer in the second large language model by using a layer fusion operator, to obtain the third large language model.

When steps S110 to S130 are executed for the first time, the dimension fusion operator may be initialized randomly. When steps S110 to S130 are executed each time subsequently, the dimension fusion operator and the layer fusion operator are updated by using the target loss function, and then steps S110 to S130 are executed by using the updated dimension fusion operator and layer fusion operator.

It should be understood that the target loss function can represent a functional difference between the first large language model and the second large language model.

Exemplarily, the target loss function may be determined based on an output distribution of the first large language model and an output distribution of the third large language model.

Exemplarily, the target loss function may be determined based on a loss function of the first large language model and a loss function of the third large language model.

Exemplarily, a loss function is determined based on the output distribution of the first large language model and the output distribution of the third large language model, and then is combined with the loss function of the first large language model and the loss function of the third large language model to obtain the target loss function.

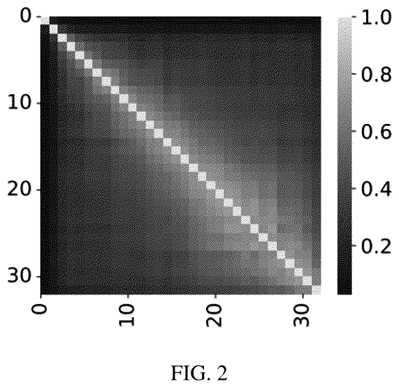

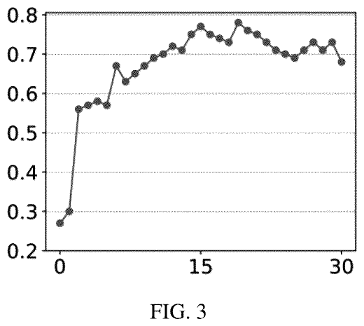

FIG. 2 is a schematic diagram illustrating a degree of similarity between parameters of each network layer in the large language model according to an embodiment of the present disclosure. FIG. 3 is a schematic diagram illustrating a degree of similarity between parameters of each network layer in the large language model according to another embodiment of the present disclosure.

A horizontal coordinate and a vertical coordinate in FIG. 2 both represent a serial number of layer where a network layer is located in the large language model, and a grayscale of grayscale bar represents the similarity. The lighter the grayscale, the higher the similarity; the darker the grayscale, the lower the similarity. As can be seen from FIG. 2, In the large language model, the more adjacent two network layers are, the higher their similarity. Moreover, the similarity between the network layers of the model presents a clustered structure, which means that there are a large number of redundant parameters in the model.

A horizontal coordinate in FIG. 3 represents a serial number of layer where a network layer is located in the large language model, and a vertical coordinate represents a similarity between a network layer and a specified network layer. As shown in FIG. 3, the maximum value of the similarity between the network layer and the specified network layer is less than 80%, which means that each network layer has a specific function and cannot be deleted simply and directly.

Therefore, the embodiment of the disclosure reduces the parameter scale of the large language model by using a parameter fusion method, ensuring that the precision or effectiveness of the fused large language model does not decrease significantly.

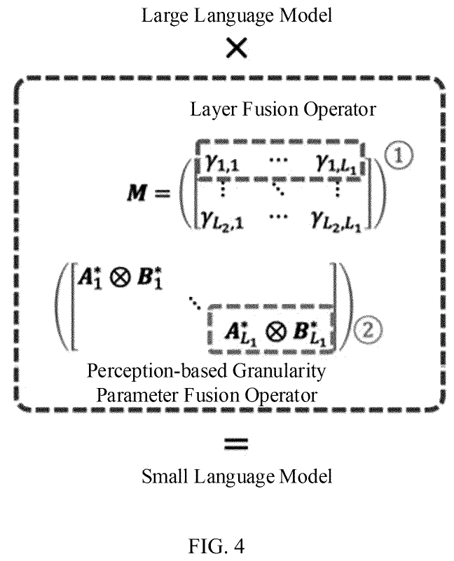

FIG. 4 is a schematic diagram illustrating a fusion process of a large language model according to an embodiment of the present disclosure.

Exemplarily, as shown in FIG. 4, in the repeated process of the above steps S110 to S130, an objective of this example is to learn a fusion operator so that the original parameters (the large language model with larger parameter scale), i.e., the above first large language model, and the fused target parameters (the large language model with smaller parameter scale), i.e., the above second large language model or third large language model, are obtained. The objective may be defined as:

$${E}_{x ∼ D} L ( x ; {Θ}^{small} - {Θ}^{large} ) , {Θ}^{small} = ( {Θ}^{large} )$$

Here, [symbol] is a fusion operator, L is a target loss function, D is a training set, and x is a training sample from the training set. Θ^{small} represents parameters of a large language model with a smaller parameter scale (hereinafter referred to as a small model), and Θ^{large} represents parameters of a large language model with a larger parameter scale (hereinafter referred to as a large model).

In an example, the fusion operator [symbol] can be decomposed into a layer fusion operator γ and a dimension fusion operator R_{dim}, the fusion operation is performed in inter-layer and intra-layer directions. The inter-layer fusion (layer fusion) involves fusing the parameters of different network layers, while the intra-layer fusion (dimension fusion) involves fusing the parameters within a single network layer.

As shown in FIG. 4, the layer fusion operator γ includes mapping coefficients from each network layer of the large model to each network layer of the small model. Here, L1 represents the number of network layers in the large model, and L2 represents the number of network layers in the small model. The dimension fusion operator R_{dim} can include a dimension fusion operator corresponding to each channel in each network layer of the large model. The dimension fusion operator can be decomposed into a row transformation matrix A or A* and a column conversion matrix B or B*. For example, A₁* represents a row conversion matrix of the first network layer in the large model.

Therefore, according to the above embodiment, when the dimension fusion and the layer fusion are performed on the large model until the above objective is reached, the target small model may be obtained. Then pre-training or training is performed on the target small model to obtain the target large language model. As such, the precision of the large language model is guaranteed, while the occupation of computing resources and memory resources in the model training process can be reduced.

In an implementation, performing the dimension reduction parameter fusion on the two-dimensional parameter matrix on each channel in each network layer in the first large language model to obtain the second large language model, includes: decomposing a dimension fusion operator to obtain a column conversion matrix and a row conversion matrix corresponding to each channel in each network layer in the first large language model; performing the column-wise dimension reduction parameter fusion on the two-dimensional parameter matrix on each channel in each network layer in the first large language model, respectively, based on the column conversion matrix corresponding to each channel in each network layer in the first large language model to obtain a fourth large language model; and performing the row-wise dimension reduction parameter fusion on the two-dimensional parameter matrix on each channel in each network in the fourth large language model, respectively, based on the row conversion matrix corresponding to each channel in each network layer in the first large language model to obtain the second large language model.

It should be understood that the dimension fusion operator is a matrix, one element of the matrix corresponds to a fusion operator of one channel, and the fusion operator can be split into a column conversion matrix and a row conversion matrix.

It should be understood that the column conversion matrix corresponding to each channel in each network layer in the first large language model is multiplied by the corresponding two-dimensional parameter matrix in the first large language model respectively to obtain a fourth large language model.

For example, the column conversion matrix corresponding to a first channel in the first large language model is multiplied by a two-dimensional parameter matrix on the first channel in the first large language model, and the multiplication operation is performed for each channel to obtain the fourth large language model.

In the above example, the row number of the column conversion matrix corresponding to the first channel is more than or equal to the column number thereof, the row number of the column conversion matrix is equal to the column number of the two-dimensional parameter matrix on the first channel in the first large language model, and the column number of the column conversion matrix is equal to the column number of the two-dimensional parameter matrix on the first channel in the fourth large language model, that is, the column number of the column conversion matrix is equal to the column number of the two-dimensional parameter matrix on the first channel in the second large language model. Therefore, after the column conversion, the effect of column-wise dimension reduction parameter fusion can be realized.

It should be understood that the row conversion matrix corresponding to each channel in each network layer in the first large language model is multiplied by the corresponding two-dimensional parameter matrix in the fourth large language model, respectively, to obtain the second large language model.

For example, the row conversion matrix corresponding to the first channel in the first large language model is multiplied by the two-dimensional parameter matrix on the first channel in the fourth large language model, and the multiplication operation is performed for each channel to obtain the fourth large language model.

In the above example, the row number of the row conversion matrix corresponding to the first channel is more than or equal to the column number thereof, the row number of the column conversion matrix is equal to the row number of the two-dimensional parameter matrix on the first channel in the first large language model, and the column number of the column conversion matrix is equal to the row number of the two-dimensional parameter matrix on the first channel in the second large language model. Therefore, after the row conversion, the effect of row-wise dimension reduction parameter fusion can be realized.

Exemplarily, the two-dimensional parameter matrix W^{large}∈ [symbol] ^{D}^{₁}^{×D}^{₂} on the first channel in the first large language model (large model) is taken as an example. To reduce the dimension of W^{large} to the two-dimensional parameter matrix W^{small}∈ [symbol] ^{D}^{₃}^{×D}^{₄} on the first channel in the second large language model (small model), its corresponding column conversion matrix is A∈ [symbol] ^{D}^{₂}^{×D}^{₄}, and the row conversion matrix is B∈ [symbol] ^{D}^{₁}^{×D}^{₃} Here, D₁ and D₂ are the numbers of rows and columns of the two-dimensional parameter matrix W^{large}, and D₃ and D₄ are the numbers of rows and columns of the two-dimensional parameter matrix W^{small}.

Exemplarily, the two-dimensional parameter matrix W^{small} corresponding to the small model can be obtained through the following operation:

$${W}^{small} = {B}^{⊤} W A$$

According to the above implementation, in the dimension reduction parameter fusion, the dimension fusion operator is decomposed into the column conversion matrix and the row conversion matrix, the column-wise dimension reduction fusion is firstly performed on the two-dimensional parameter matrix of the large model, and then the row-wise dimension reduction fusion is carried out, thereby decreasing the computing resources and the memory resources occupied by the model parameters in the dimension reduction fusion process and increasing the dimension reduction fusion speed of the model parameters.

In an implementation, performing the column-wise dimension reduction parameter fusion on the two-dimensional parameter matrix on each channel in each network layer in the first large language model, respectively, based on the column conversion matrix corresponding to each channel in each network layer in the first large language model to obtain the fourth large language model, includes: for a first column conversion matrix corresponding to a first channel in a first network layer in the first large language model, under the condition that a first difference value between a row number of the first column conversion matrix and a column number of a corresponding two-dimensional parameter matrix in the first large language model meets a first difference value condition, updating the first column conversion matrix based on a ratio of the row number of the first column conversion matrix to a preset column receptive field value; and multiplying the updated first column conversion matrix by the corresponding two-dimensional parameter matrix in the first large language model to perform the column-wise dimension reduction parameter fusion, wherein the column receptive field value is more than 1.

It should be understood that if the row number of the first column conversion matrix is similar to the column number of the corresponding two-dimensional parameter matrix in the first large language model, the first column conversion matrix will have a large size, resulting in excessive resource consumption in the subsequent dimension reduction parameter fusion process. Therefore, in order to minimize the requirements of the training process on the memory resources and the computing resources, the column receptive field value can be used for performing the row-wise dimension reduction on the first column conversion matrix, so that the size of the first column conversion matrix after the dimension reduction is reduced, and the occupation of the computing resources and the memory resources in the subsequent dimension reduction parameter fusion process is decreased.

Exemplarily, the first difference value condition is that the first difference value is more than or equal to zero or a certain negative number.

Exemplarily, the row number of the first column conversion matrix after updating is a ratio of the row number of the first column conversion matrix before updating to the preset column receptive field value. The column number of the first column conversion matrix after updating is equal to the column number of the first column conversion matrix before updating.

Exemplarily, the column conversion matrix before updating is A∈ [symbol] ^{D}^{₂}^{×D}^{₄}, and the column conversion matrix after updating is A*∈ [symbol] ^{(D}^{₂}^{/r}^{_{A}}^{)×D}^{₄}, where r_{A} is a preset column receptive field value. Thus, the original column conversion matrix A with D₂×D₄ parameters can be reduced to a column conversion matrix A* with (D₂/r_{A})×D₄ parameters, where r_{A} is more than 1.

According to the above implementation, the row-wise dimension reduction in the column conversion matrix is firstly performed, and then the column conversion matrix after dimension reduction is multiplied by the corresponding two-dimensional parameter matrix in the large model to realize the column-wise dimension reduction parameter fusion, so that the computing resources and the memory resources occupied in the training process can be further decreased.

In an implementation, performing the row-wise dimension reduction parameter fusion on the two-dimensional parameter matrix on each channel in each network in the fourth large language model, respectively, based on the row conversion matrix corresponding to each channel in each network layer in the first large language model to obtain the second large language model, includes: for a first row conversion matrix corresponding to a first channel in a first network layer in the first large language model, under the condition that a second difference value between a row number of the first row conversion matrix and a row number of the corresponding two-dimensional parameter matrix in the first large language model meets a second difference value condition, updating the first row conversion matrix based on a ratio of the row number of the first row conversion matrix to a preset row receptive field value; and multiplying the updated first row conversion matrix by the corresponding two-dimensional parameter matrix in the first large language model to perform the row-wise dimension reduction parameter fusion, wherein the row receptive field value is more than 1.

It should be understood that if the row number of the first row conversion matrix is similar to the row number of the corresponding two-dimensional parameter matrix in the first large language model, the first row conversion matrix will have a large size, resulting in excessive resource consumption in the subsequent dimension reduction parameter fusion process. Therefore, in order to minimize the requirements of the training process on the memory resources and the computing resources, the row receptive field value can be used for performing the row-wise dimension reduction on the first row conversion matrix, so that the size of the first row conversion matrix after dimension reduction is reduced, and the occupation of the computing resources and the memory resources in the subsequent dimension reduction parameter fusion process is decreased.

Exemplarily, the second difference value condition is that the second difference value is more than or equal to zero or a certain negative number.

Exemplarily, the row number of the first row conversion matrix after updating is a ratio of the row number of the first row conversion matrix before updating to the preset row receptive field value. The column number of the first column conversion matrix after updating is equal to the column number of the first column conversion matrix before updating.

Exemplarily, the row conversion matrix before updating is B∈ [symbol] ^{D}^{₁}^{×D}^{₃}, and the row conversion matrix after updating is B*∈ [symbol] ^{(D}^{₁}^{/r}^{_{B}}^{)×D}^{₃}, where r_{B} is a preset row receptive field value, and r_{B} is more than 1. Thus, the original row conversion matrix B with D₁×D₃ parameters can be reduced to a row conversion matrix B* with (D₁/r_{B})×D₃ parameters.

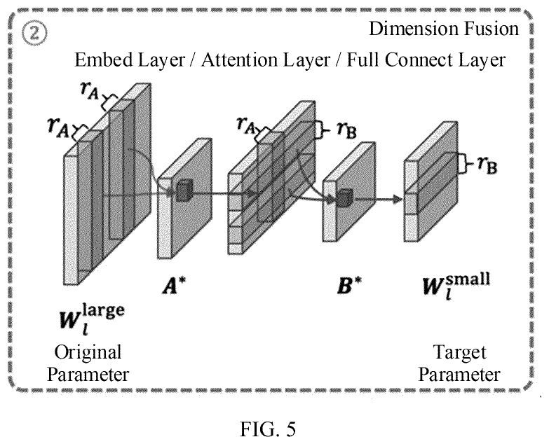

Exemplarily, FIG. 5 illustrates a process of the dimension reduction parameter fusion, which corresponds to part 2 in FIG. 4, i.e., the dimension fusion. For the two-dimensional parameter matrix Wₗ^{large} of a certain channel in the l-th layer of a large model (i.e., original parameters), a linear fusion of column-wise dimension vector is performed on the large model are using the matrix A* with a column receptive field of r_{A}. Next, a linear fusion of row-wise dimension vector is performed on the large model using the matrix B* with a row receptive field of r_{B}. Ultimately, the parameter matrix Wₗ^{small} of the certain channel in the l-th layer of a small model (i.e., target parameters) is obtained.

According to the above implementation, the row-wise dimension reduction in the row conversion matrix is performed, and then the row conversion matrix after dimension reduction is multiplied by the corresponding two-dimensional parameter matrix in the large model to realize the row-wise dimension reduction parameter fusion. As such, the computing resources and the memory resources occupied in the training process of the large language model can be further reduced.

In an implementation, the method may further include: adjusting the dimension fusion operator based on the target loss function under the condition that the target loss function does not meet the first function condition.

It should be understood that the layer fusion operator is updated or adjusted by using the gradient information in the target loss function, and then the updated or adjusted dimension fusion operator is returned to continue to execute the above steps of the dimension reduction parameter fusion, the layer reduction parameter fusion and the target loss function calculation until the target loss function meets the first function condition.

It should be understood that some or all of parameters of the dimension fusion operator are adjusted.

It should be understood that under the condition that the target loss function does not meet the first function condition, the parameters of the first large language model can also be updated or adjusted based on the target loss function at the same time. Then, the updated first large language model and the updated or adjusted dimension fusion operator are returned to continue to execute the above steps S110 to S130 until the target loss function meets the first function condition.

According to the above implementation, in the pre-training process, the functional difference between the first large language model and the third large language model can be minimized by continuously adjusting the dimension fusion operator, that is, the target loss function reaches the first function condition.

In an implementation, performing the layer reduction parameter fusion on the network layers in the second large language model based on the three-dimensional parameter matrix of each network layer in the second large language model to obtain the third large language model, includes: determining a mapping coefficient from each network layer in a first model to each network layer in a second model based on a layer fusion operator, wherein the number of network layers in the first model is equal to the number of network layers in the second large language model; for each second network layer in the second model, obtaining a three-dimensional parameter matrix of the second network layer based on the three-dimensional parameter matrix of each network layer in the second large language model and the mapping coefficient from each network layer in the first model to the second network layer, respectively; and determining the third large language model based on the three-dimensional parameter matrix of each second network layer.

It should be understood that the layer fusion operator can be interpreted as an inter-layer mapping operator γ∈ [symbol] ^{L}^{₁}^{×L}^{₂}, which includes the mapping coefficient from each network layer in the first model to each network layer in the second model, where L₁ is the number of layers in the first model, and L₂ is the number of layers in the second model.

Exemplarily, the number of layers in the first model is more than or equal to the number of layers in the second model.

Exemplarily, the first model is a large model and the second model is a small model.

It should be noted that, in the embodiment of the present disclosure, the large model may be understood as a model with a larger parameter scale, and the small model may be understood as a model with a smaller parameter scale.

The inter-layer mapping operator γ includes the mapping coefficient γ_{i,j} from the j-th layer in the first model to the i-th layer in the second model.

It should be understood that the second network layer is any network layer in the second model.

It should be understood that the first model corresponds to the second large language model, and the second model corresponds to the third large language model.

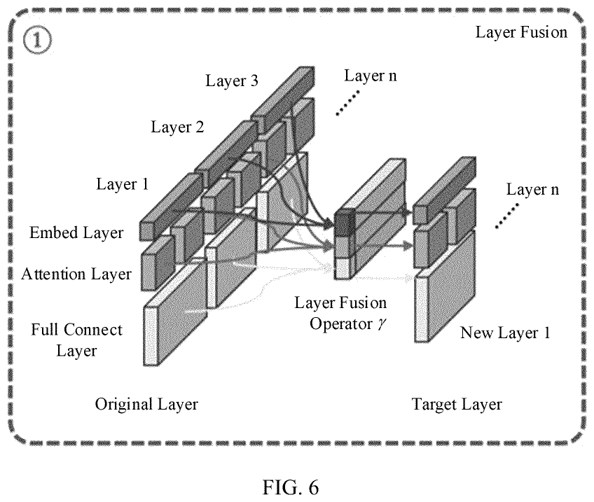

As shown in FIGS. 4 and 6, FIG. 6 illustrates the process of layer reduction parameter fusion, which corresponds to part \textcircled{1} in FIG. 4, i.e., the layer fusion. The original network layers are fused through the layer fusion operator γ to obtain a new network layer, i.e., a target layer.

According to the above implementation, based on the three-dimensional parameter matrix of each network layer in the model with the larger parameter scale and the mapping coefficient from each network layer in the model with the larger parameter scale to the second network layer specified by the model with the smaller parameter scale, the three-dimensional parameter matrix of the second network layer specified by the model with the smaller parameter scale can be obtained. Thus, the third large language model may be composed based on the three-dimensional parameter matrix of each second network layer.

In an implementation, obtaining the three-dimensional parameter matrix of the second network layer based on the three-dimensional parameter matrix of each network layer in the second large language model and the mapping coefficient from each network layer in the first model to the second network layer, includes: multiplying the three-dimensional parameter matrix of each network layer in the second large language model by a mapping coefficient from a corresponding network layer in the first model to the second network layer, respectively, to obtain a plurality of three-dimensional parameter matrices; and summing the plurality of three-dimensional parameter matrixes to obtain the three-dimensional parameter matrix of the second network layer.

Exemplarily, for the three-dimensional parameter matrix Θⱼ^{large} of the j-th layer in the second large language model and the inter-layer mapping operator γ∈ [symbol] ^{L}^{₁}^{×L}^{₂}, the calculation formula for the parameters Θᵢ^{small} of the i-th layer in the third large language model is as follows:

$${Θ}_{i}^{s m a l l} = {\sum }_{j = 1}^{{L}_{1}} {γ}_{i , j} {Θ}_{j}^{large}$$

From the above, the parameters of each network layer in the small model can be obtained by linearly fusing the parameters of each network layer in the large model.

According to the above implementation, the parameters of each layer of the large model and the mapping coefficient from each layer of the large model to the i-th layer of the small model are multiplied and summed, respectively, to obtain the parameters of the i-th layer of the small model.

In an implementation, the method may further include: adjusting the layer fusion operator based on the target loss function under the condition that the target loss function does not meet the first function condition.

It should be understood that under the condition that the target loss function does not meet the first function condition, the dimension fusion operator and the layer fusion operator are adjusted based on the target loss function.

It should be understood that the layer fusion operator is updated or adjusted by using the gradient information in the target loss function, and then the updated or adjusted layer fusion operator is returned to execute the above steps of the dimension reduction parameter fusion, the layer reduction parameter fusion and the target loss function calculation until the target loss function meets the first function condition.

It should be understood that some or all of the parameters of the layer fusion operator are adjusted.

It should be understood that under the condition that the target loss function does not meet the first function condition, the parameters of the first large language model can also be updated or adjusted based on the target loss function at the same time. Then, the updated first large language model and the updated or adjusted layer fusion operator and dimension fusion operator are returned to continue to execute the above steps S110 to S130 until the target loss function meets the first function condition.

According to the above implementation, in the pre-training process, the functional difference between the first large language model and the third large language model can be minimized by continuously adjusting the layer fusion operator, that is, the target loss function reaches the first function condition.

In an implementation, determining the target loss function based on the first large language model and the third large language model, includes: determining a first loss function and a first output distribution of the first large language model based on a first training sample set; determining a second loss function and a second output distribution of the third large language model based on a second training sample set; determining a third loss function based on the first output distribution and the second output distribution; and performing weighted summation on the first loss function, the second loss function and the third loss function to obtain the target loss function.

It should be understood that, to quantify difference in the output distributions between the large and small models, a KL divergence may be added to the target loss function.

It should be understood that the first loss function measures the difference between an actual output result and an annotated output result when the first large language model is obtained by training with the first training sample set.

It should be understood that the first output distribution measures an output distribution of the first large language model.

It should be understood that the second loss function measures the difference between an actual output result and an annotated output result when the third large language model is obtained by training with the second training sample set.

It should be understood that the second output distribution measures an output distribution of the third large language model.

It should be understood that, the first output distribution and the second output distribution are calculated using a KL divergence function to obtain a target KL divergence, which is the third loss function.

Exemplarily, the target loss function is calculated using the following formula:

$${L}_{final} = λ {L}_{lm} + ( 1 - λ ) {L}_{k l}$$

Here, L_{final} is the target loss function, Lₗₘ is the sum of the first loss function and the second loss function, Lₖₗ is the third loss function, and λ is the weighting coefficient.

According to the above implementation, the target loss function can measure not only the loss of the first large language model before fusion and the loss of the third large language model after fusion, but also the difference between the output distributions of the two models before and after fusion. Thus, in training, the target loss function is minimized, i.e., the difference between the functionality and accuracy of the two models before and after fusion can be minimized.

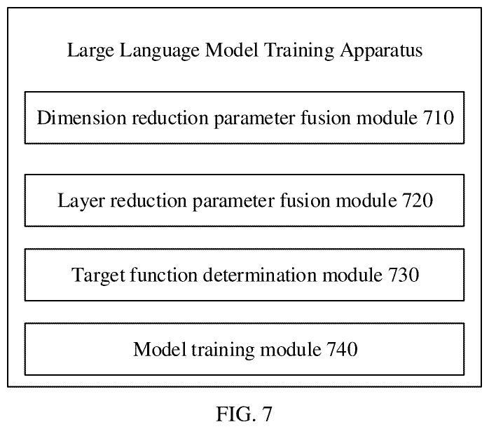

FIG. 7 is a block diagram of a large language model training apparatus according to an embodiment of the present disclosure.

As shown in FIG. 7, the large language model training apparatus may include:
a dimension reduction parameter fusion module 710, configured to perform dimension reduction parameter fusion on a two-dimensional parameter matrix on each channel in each network layer in a first large language model, respectively, to obtain a second large language model;
a layer reduction parameter fusion module 720, configured to perform layer reduction parameter fusion on network layers in the second large language model based on a three-dimensional parameter matrix of each network layer in the second large language model to obtain a third large language model;
a target function determination module 730, configured to determine a target loss function based on the first large language model and the third large language model; and
a model training module 740, configured to train the third large language model to obtain a target large language model under the condition that the target loss function meets a preset first function condition.

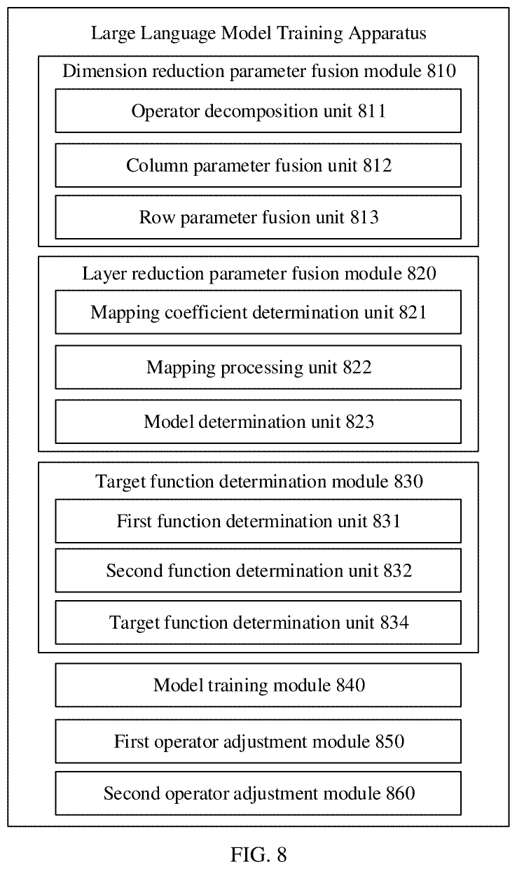

FIG. 8 is a block diagram of a large language model training apparatus according to another embodiment of the present disclosure.

As shown in FIGS. 7 and 8, the dimension reduction parameter fusion module 810, the layer reduction parameter fusion module 820, the target function determination module 830 and the model training module 840 in FIG. 8 have the same structure and function as the dimension reduction parameter fusion module 710, the layer reduction parameter fusion module 720, the target function determination module 730 and the model training module 740 in FIG. 7, respectively, and will not be described in detail herein.

In an implementation, as shown in FIG. 8, the dimension reduction parameter fusion module 810 includes:
an operator decomposition unit 811, configured to decompose a dimension fusion operator to obtain a column conversion matrix and a row conversion matrix corresponding to each channel in each network layer in the first large language model;
a column parameter fusion unit 812, configured to perform the column-wise dimension reduction parameter fusion on the two-dimensional parameter matrix on each channel in each network layer in the first large language model, respectively, based on the column conversion matrix corresponding to each channel in each network layer in the first large language model to obtain a fourth large language model; and
a row parameter fusion unit 813, configured to perform the row-wise dimension reduction parameter fusion on the two-dimensional parameter matrix on each channel in each network in the fourth large language model, respectively, based on the row conversion matrix corresponding to each channel in each network layer in the first large language model to obtain the second large language model.

In an implementation, the column parameter fusion unit 812 is specifically configured to:
for a first column conversion matrix corresponding to a first channel in a first network layer in the first large language model, under the condition that a first difference value between a row number of the first column conversion matrix and a column number of a corresponding two-dimensional parameter matrix in the first large language model meets a first difference value condition, update the first column conversion matrix based on a ratio of the row number of the first column conversion matrix to a preset column receptive field value; and
multiply the updated first column conversion matrix by the corresponding two-dimensional parameter matrix in the first large language model to perform the column-wise dimension reduction parameter fusion,
wherein the column receptive field value is more than 1.

In an implementation, the row parameter fusion unit 813 is specifically configured to:
for a first row conversion matrix corresponding to a first channel in a first network layer in the first large language model, under the condition that a second difference value between a row number of the first row conversion matrix and a row number of a corresponding two-dimensional parameter matrix in the first large language model meets a second difference value condition, update the first row conversion matrix based on a ratio of the row number of the first row conversion matrix to a preset row receptive field value; and
multiply the updated first row conversion matrix by the corresponding two-dimensional parameter matrix in the first large language model to perform the row-wise dimension reduction parameter fusion,
wherein the row receptive field value is more than 1.

In an implementation, as shown in FIG. 8, the apparatus further includes:
a first operator adjustment module 850, configured to adjust the dimension fusion operator based on the target loss function under the condition that the target loss function does not meet the first function condition.

In an implementation, as shown in FIG. 8, the layer reduction parameter fusion module 820 includes:
a mapping coefficient determination unit 821, configured to determine a mapping coefficient from each network layer in a first model to each network layer in a second model based on a layer fusion operator, wherein the number of network layers in the first model is equal to the number of network layers in the second large language model;
a mapping processing unit 822, configured to, for each second network layer in the second model, obtain a three-dimensional parameter matrix of the second network layer based on the three-dimensional parameter matrix of each network layer in the second large language model and the mapping coefficient from each network layer in the first model to the second network layer, respectively; and
a model determination unit 823, configured to determine the third large language model based on the three-dimensional parameter matrix of each second network layer.

In an implementation, the mapping processing unit 822 is specifically configured to:
multiply the three-dimensional parameter matrix of each network layer in the second large language model by a mapping coefficient from a corresponding network layer in the first model to the second network layer, respectively, to obtain a plurality of three-dimensional parameter matrices; and
sum the three-dimensional parameter matrixes to obtain the three-dimensional parameter matrix of the second network layer.

In an implementation, as shown in FIG. 8, the apparatus further includes:
a second operator adjustment module 860, configured to adjust the layer fusion operator based on the target loss function under the condition that the target loss function does not meet the first function condition.

In an implementation, as shown in FIG. 8, the target function determination module 830 includes:
a first function determination unit 831, configured to determine a first loss function and a first output distribution of the first large language model based on a first training sample set;
a second function determination unit 832, configured to determine a second loss function and a second output distribution of the third large language model based on a second training sample set;
a third function determination unit 833, configured to determine a third loss function based on the first output distribution and the second output distribution; and
a target function determination unit 834, configured to perform weighted summation on the first loss function, the second loss function and the third loss function to obtain the target loss function.

For a description of specific functions and examples of each module and each sub-module of the apparatus according to the embodiment of the present disclosure, reference may be made to the related description of the corresponding steps in the foregoing method embodiments, and details thereof are not repeated herein.

In the technical solution of the present disclosure, the acquisition, storage and application of the user's personal information involved are all in compliance with the provisions of relevant laws and regulations, and do not violate public order and good customs.

According to the embodiments of the present disclosure, the present disclosure also provides an electronic device, a readable storage medium and a computer program product.

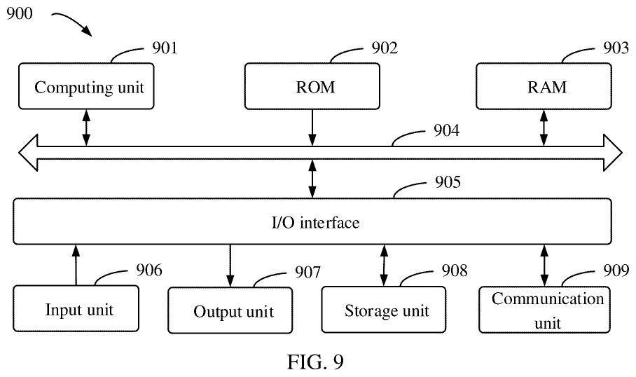

FIG. 9 shows a schematic block diagram of an exemplary electronic device 900 that may be used to implement the embodiments of the present disclosure. The electronic device is intended to represent various forms of digital computers, such as a laptop, a desktop, a workstation, a personal digital assistant, a server, a blade server, a mainframe computer, and other suitable computers. The electronic device may also represent various forms of mobile devices, such as a personal digital processing, a cellular phone, a smart phone, a wearable device and other similar computing devices. The components shown herein, their connections and relationships, and their functions are merely examples, and are not intended to limit the implementation of the present disclosure described and/or required herein.

As shown in FIG. 9, the electronic device 900 includes a computing unit 901 that may perform various appropriate actions and processes according to a computer program stored in a Read-Only Memory (ROM) 902 or a computer program loaded from a storage unit 908 into a Random Access Memory (RAM) 903. Various programs and data required for an operation of the electronic device 900 may also be stored in the RAM 903. The computing unit 901, the ROM 902 and the RAM 903 are connected to each other through a bus 904. The input/output (I/O) interface 905 is also connected to the bus 904.

A plurality of components in the electronic device 900 are connected to the I/O interface 905, and include an input unit 906 such as a keyboard, a mouse, or the like; an output unit 907 such as various types of displays, speakers, or the like; the storage unit 908 such as a magnetic disk, an optical disk, or the like; and a communication unit 909 such as a network card, a modem, a wireless communication transceiver, or the like. The communication unit 909 allows the electronic device 900 to exchange information/data with other devices through a computer network such as the Internet and/or various telecommunication networks.

The computing unit 901 may be various general-purpose and/or special-purpose processing components with processing and computing capabilities. Some examples of the computing unit 901 include, but are not limited to, a Central Processing Unit (CPU), a Graphics Processing Unit (GPU), various dedicated Artificial Intelligence (AI) computing chips, various computing units that run machine learning model algorithms, a Digital Signal Processor (DSP), and any appropriate processors, controllers, microcontrollers, or the like. The computing unit 901 performs various methods and processing described above, such as the above large language model training method. For example, in some implementations, the above large language model training method may be implemented as a computer software program tangibly contained in a computer-readable medium, such as the storage unit 908. In some implementations, a part or all of the computer program may be loaded and/or installed on the device 900 via the ROM 902 and/or the communication unit 909. When the computer program is loaded into RAM 903 and executed by the computing unit 901, one or more steps of the large language model training method described above may be performed. Alternatively, in other implementations, the computing unit 901 may be configured to perform the above large language model training method by any other suitable means (e.g., by means of firmware).

Various implements of the system and technologies described above herein may be implemented in a digital electronic circuit system, an integrated circuit system, a Field Programmable Gate Array (FPGA), an Application Specific Integrated Circuit (ASIC), Application Specific Standard Parts (ASSP), a System on Chip (SOC), a Complex Programmable Logic Device (CPLD), a computer hardware, firmware, software, and/or a combination thereof. These various implementations may be implemented in one or more computer programs, and the one or more computer programs may be executed and/or interpreted on a programmable system including at least one programmable processor. The programmable processor may be a special-purpose or general-purpose programmable processor, may receive data and instructions from a storage system, at least one input device, and at least one output device, and transmit the data and the instructions to the storage system, the at least one input device, and the at least one output device.

The program code for implementing the method of the present disclosure may be written in any combination of one or more programming languages. The program code may be provided to a processor or controller of a general-purpose computer, a special-purpose computer or other programmable data processing devices, which enables the program code, when executed by the processor or controller, to cause the function/operation specified in the flowchart and/or block diagram to be implemented. The program code may be completely executed on a machine, partially executed on the machine, partially executed on the machine as a separate software package and partially executed on a remote machine, or completely executed on the remote machine or a server.

In the context of the present disclosure, a machine-readable medium may be a tangible medium, which may contain or store a procedure for use by or in connection with an instruction execution system, device or apparatus. The machine-readable medium may be a machine-readable signal medium or a machine-readable storage medium. The machine-readable medium may include, but is not limited to, an electronic, magnetic, optical, electromagnetic, infrared or semiconductor system, device or apparatus, or any suitable combination thereof. More specific examples of the machine-readable storage medium may include electrical connections based on one or more lines, a portable computer disk, a hard disk, a Random Access Memory (RAM), a Read-Only Memory (ROM), an Erasable Programmable Read-Only Memory (EPROM or a flash memory), an optical fiber, a portable Compact Disc Read-Only Memory (CD-ROM), an optical storage device, a magnetic storage device, or any suitable combination thereof.

In order to provide interaction with a user, the system and technologies described herein may be implemented on a computer that has: a display apparatus (e.g., a cathode ray tube (CRT) or a Liquid Crystal Display (LCD) monitor) for displaying information to the user; and a keyboard and a pointing device (e.g., a mouse or a trackball) through which the user may provide input to the computer. Other types of devices may also be used to provide interaction with the user. For example, feedback provided to the user may be any form of sensory feedback (e.g., visual feedback, auditory feedback, or tactile feedback), and the input from the user may be received in any form (including an acoustic input, a voice input, or a tactile input).

The system and technologies described herein may be implemented in a computing system (which serves as, for example, a data server) including a back-end component, or in a computing system (which serves as, for example, an application server) including a middleware, or in a computing system including a front-end component (e.g., a user computer with a graphical user interface or web browser through which the user may interact with the implementation of the system and technologies described herein), or in a computing system including any combination of the back-end component, the middleware component, or the front-end component. The components of the system may be connected to each other through any form or kind of digital data communication (e.g., a communication network). Examples of the communication network include a Local Area Network (LAN), a Wide Area Network (WAN), and the Internet.

A computer system may include a client and a server. The client and server are generally far away from each other and usually interact with each other through a communication network. A relationship between the client and the server is generated by computer programs running on corresponding computers and having a client-server relationship with each other. The server may be a cloud server, a distributed system server, or a blockchain server.

It should be understood that, the steps may be reordered, added or removed by using the various forms of the flows described above. For example, the steps recorded in the present disclosure can be performed in parallel, in sequence, or in different orders, as long as a desired result of the technical scheme disclosed in the present disclosure can be realized, which is not limited herein.

The foregoing specific implementations do not constitute a limitation on the protection scope of the present disclosure. Those having ordinary skill in the art should understand that, various modifications, combinations, sub-combinations and substitutions may be made according to a design requirement and other factors. Any modification, equivalent replacement, improvement or the like made within the spirit and principle of the present disclosure shall be included in the protection scope of the present disclosure.

What is claimed is:

1. A large language model training method, comprising:
performing dimension reduction parameter fusion on a two-dimensional parameter matrix on each channel in each network layer in a first large language model, respectively, to obtain a second large language model;
performing layer reduction parameter fusion on network layers in the second large language model based on a three-dimensional parameter matrix of each network layer in the second large language model to obtain a third large language model;
determining a target loss function based on the first large language model and the third large language model; and
training the third large language model to obtain a target large language model after determining that the target loss function meets a preset first function condition.

2. The method of claim 1, wherein the performing the dimension reduction parameter fusion comprises:
decomposing a dimension fusion operator to obtain a column conversion matrix and a row conversion matrix corresponding to each channel in each network layer in the first large language model;
performing column-wise dimension reduction parameter fusion on the two-dimensional parameter matrix on each channel in each network layer in the first large language model, respectively, based on the column conversion matrix corresponding to each channel in each network layer in the first large language model to obtain a fourth large language model; and
performing row-wise dimension reduction parameter fusion on the two-dimensional parameter matrix on each channel in each network layer in the fourth large language model, respectively, based on the row conversion matrix corresponding to each channel in each network layer in the first large language model to obtain the second large language model.

3. The method of claim 2, wherein the performing the column-wise dimension reduction parameter fusion comprises:
for a first column conversion matrix corresponding to a first channel in a first network layer in the first large language model, after determining that a first difference value between a row number of the first column conversion matrix and a column number of a corresponding two-dimensional parameter matrix in the first large language model meets a first difference value condition, updating the first column conversion matrix based on a ratio of the row number of the first column conversion matrix to a preset column receptive field value; and
multiplying the updated first column conversion matrix by the corresponding two-dimensional parameter matrix in the first large language model to perform the column-wise dimension reduction parameter fusion,
wherein the preset column receptive field value is more than 1.

4. The method of claim 2, wherein the performing the row-wise dimension reduction parameter fusion comprises:
for a first row conversion matrix corresponding to a first channel in a first network layer in the first large language model, after determining that a second difference value between a row number of the first row conversion matrix and a row number of a corresponding two-dimensional parameter matrix in the first large language model meets a second difference value condition, updating the first row conversion matrix based on a ratio of the row number of the first row conversion matrix to a preset row receptive field value; and
multiplying the updated first row conversion matrix by the corresponding two-dimensional parameter matrix in the first large language model to perform the row-wise dimension reduction parameter fusion,
wherein the preset row receptive field value is more than 1.

5. The method of claim 2, further comprising:
adjusting the dimension fusion operator based on the target loss function after determining that the target loss function does not meet the preset first function condition.

6. The method of claim 1, wherein the performing the layer reduction parameter fusion on the network layers in the second large language model comprises:
determining a mapping coefficient from each network layer in a first model to each network layer in a second model based on a layer fusion operator, wherein a number of network layers in the first model is equal to a number of network layers in the second large language model;
for each second network layer in the second model, obtaining a three-dimensional parameter matrix of the second network layer based on the three-dimensional parameter matrix of each network layer in the second large language model and the mapping coefficient from each network layer in the first model to the second network layer, respectively; and
determining the third large language model based on the three-dimensional parameter matrix of each second network layer.

7. The method of claim 6, wherein the obtaining the three-dimensional parameter matrix of the second network layer comprises:
multiplying the three-dimensional parameter matrix of each network layer in the second large language model by the mapping coefficient from a corresponding network layer in the first model to the second network layer, respectively, to obtain a plurality of three-dimensional parameter matrices; and
summing the plurality of three-dimensional parameter matrices to obtain the three-dimensional parameter matrix of the second network layer.

8. The method of claim 6, further comprising:
adjusting the layer fusion operator based on the target loss function after determining that the target loss function does not meet the preset first function condition.

9. The method of claim 1, wherein the determining the target loss function based on the first large language model and the third large language model comprises:
determining a first loss function and a first output distribution of the first large language model based on a first training sample set;
determining a second loss function and a second output distribution of the third large language model based on a second training sample set;
determining a third loss function based on the first output distribution and the second output distribution; and
performing weighted summation on the first loss function, the second loss function and the third loss function to obtain the target loss function.

10. An electronic device, comprising:
at least one processor; and
a memory connected in communication with the at least one processor,
wherein the memory stores an instruction executable by the at least one processor, and the instruction, when executed by the at least one processor, enables the at least one processor to execute:
performing dimension reduction parameter fusion on a two-dimensional parameter matrix on each channel in each network layer in a first large language model, respectively, to obtain a second large language model;
performing layer reduction parameter fusion on network layers in the second large language model based on a three-dimensional parameter matrix of each network layer in the second large language model to obtain a third large language model;
determining a target loss function based on the first large language model and the third large language model; and
training the third large language model to obtain a target large language model after determining that the target loss function meets a preset first function condition.

11. The electronic device of claim 10, wherein the instruction, when executed by the at least one processor, enables the at least one processor to execute: performing the dimension reduction parameter fusion by:
decomposing a dimension fusion operator to obtain a column conversion matrix and a row conversion matrix corresponding to each channel in each network layer in the first large language model;
performing column-wise dimension reduction parameter fusion on the two-dimensional parameter matrix on each channel in each network layer in the first large language model, respectively, based on the column conversion matrix corresponding to each channel in each network layer in the first large language model to obtain a fourth large language model; and
performing row-wise dimension reduction parameter fusion on the two-dimensional parameter matrix on each channel in each network layer in the fourth large language model, respectively, based on the row conversion matrix corresponding to each channel in each network layer in the first large language model to obtain the second large language model.

12. The electronic device of claim 11, wherein the instruction, when executed by the at least one processor, enables the at least one processor to execute: performing the column-wise dimension reduction parameter fusion by:
for a first column conversion matrix corresponding to a first channel in a first network layer in the first large language model, after determining that a first difference value between a row number of the first column conversion matrix and a column number of a corresponding two-dimensional parameter matrix in the first large language model meets a first difference value condition, updating the first column conversion matrix based on a ratio of the row number of the first column conversion matrix to a preset column receptive field value; and
multiplying the updated first column conversion matrix by the corresponding two-dimensional parameter matrix in the first large language model to perform the column-wise dimension reduction parameter fusion,
wherein the preset column receptive field value is more than 1.

13. The electronic device of claim 11, wherein the instruction, when executed by the at least one processor, enables the at least one processor to execute: performing the row-wise dimension reduction parameter fusion by:
for a first row conversion matrix corresponding to a first channel in a first network layer in the first large language model, after determining that a second difference value between a row number of the first row conversion matrix and a row number of a corresponding two-dimensional parameter matrix in the first large language model meets a second difference value condition, updating the first row conversion matrix based on a ratio of the row number of the first row conversion matrix to a preset row receptive field value; and
multiplying the updated first row conversion matrix by the corresponding two-dimensional parameter matrix in the first large language model to perform the row-wise dimension reduction parameter fusion,
wherein the preset row receptive field value is more than 1.

14. The electronic device of claim 11, wherein the instruction, when executed by the at least one processor, enables the at least one processor to further execute:
adjusting the dimension fusion operator based on the target loss function after determining that the target loss function does not meet the preset first function condition.

15. The electronic device of claim 10, wherein the instruction, when executed by the at least one processor, enables the at least one processor to execute: performing the layer reduction parameter fusion by:
determining a mapping coefficient from each network layer in a first model to each network layer in a second model based on a layer fusion operator, wherein a number of network layers in the first model is equal to a number of network layers in the second large language model;
for each second network layer in the second model, obtaining a three-dimensional parameter matrix of the second network layer based on the three-dimensional parameter matrix of each network layer in the second large language model and the mapping coefficient from each network layer in the first model to the second network layer, respectively; and
determining the third large language model based on the three-dimensional parameter matrix of each second network layer.

16. A non-transitory computer readable storage medium storing a computer instruction wherein the computer instruction causes a computer to perform:
performing dimension reduction parameter fusion on a two-dimensional parameter matrix on each channel in each network layer in a first large language model, respectively, to obtain a second large language model;
performing layer reduction parameter fusion on network layers in the second large language model based on a three-dimensional parameter matrix of each network layer in the second large language model to obtain a third large language model;
determining a target loss function based on the first large language model and the third large language model; and
training the third large language model to obtain a target large language model after determining that the target loss function meets a preset first function condition.

17. The non-transitory computer readable storage medium of claim 16, wherein the computer instruction causes the computer to perform the dimension reduction parameter fusion by:
decomposing a dimension fusion operator to obtain a column conversion matrix and a row conversion matrix corresponding to each channel in each network layer in the first large language model;
performing column-wise dimension reduction parameter fusion on the two-dimensional parameter matrix on each channel in each network layer in the first large language model, respectively, based on the column conversion matrix corresponding to each channel in each network layer in the first large language model to obtain a fourth large language model; and
performing row-wise dimension reduction parameter fusion on the two-dimensional parameter matrix on each channel in each network layer in the fourth large language model, respectively, based on the row conversion matrix corresponding to each channel in each network layer in the first large language model to obtain the second large language model.

18. The non-transitory computer readable storage medium of claim 17, wherein the computer instruction causes the computer to perform the column-wise dimension reduction parameter fusion by:
for a first column conversion matrix corresponding to a first channel in a first network layer in the first large language model, after determining that a first difference value between a row number of the first column conversion matrix and a column number of a corresponding two-dimensional parameter matrix in the first large language model meets a first difference value condition, updating the first column conversion matrix based on a ratio of the row number of the first column conversion matrix to a preset column receptive field value; and
multiplying the updated first column conversion matrix by the corresponding two-dimensional parameter matrix in the first large language model to perform the column-wise dimension reduction parameter fusion,
wherein the preset column receptive field value is more than 1.

19. The non-transitory computer readable storage medium of claim 17, wherein the computer instruction causes the computer to perform the row-wise dimension reduction parameter fusion by:
for a first row conversion matrix corresponding to a first channel in a first network layer in the first large language model, after determining that a second difference value between a row number of the first row conversion matrix and a row number of a corresponding two-dimensional parameter matrix in the first large language model meets a second difference value condition, updating the first row conversion matrix based on a ratio of the row number of the first row conversion matrix to a preset row receptive field value; and
multiplying the updated first row conversion matrix by the corresponding two-dimensional parameter matrix in the first large language model to perform the row-wise dimension reduction parameter fusion,
wherein the preset row receptive field value is more than 1.

20. The non-transitory computer readable storage medium of claim 17, wherein the computer instruction causes the computer to further perform:
adjusting the dimension fusion operator based on the target loss function after determining that the target loss function does not meet the preset first function condition.
